(19) United States
(12) Patent Application Publication
(10) Pub. No.: US 2003/0227585 A1
(43) Pub. Date: Dec. 11, 2003

(54) Multi-color liquid crystal display device

(76) Inventors: Pin Chang, Hsinchu (TW); Heng-Chung Wu, Hsinchu Hsien (TW); Alex Lin, Miaoli (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/162,869

(22) Filed: Jun. 6, 2002

(51) Int. Cl. G02F 1/133

(52) U.S. Cl. 349/74

(57) ABSTRACT

The present invention provides a multi-color LCD device comprises two liquid crystal panels stacked up and down. A first polarizer, a second polarizer, and a third polarizer or a reflector are disposed above, between, and below these two liquid crystal panels, respectively. Each of the polarizers has a transmission axis and an absorption axis orthogonal to each other. The transmission axis of each of the polarizers lets white light be transmitted. The absorption axes of the first and second polarizers absorb lights of complementary colors. The absorption axis of the third polarizer absorbs white light. Through whether applying voltages onto the two liquid crystal panels or not, different color displaying effects can be achieved. The present invention has the advantage of low cost.

### FIELD OF THE INVENTION

The present invention relates to a display and, more particularly, to a multi-color liquid crystal display (LCD) device having a low manufacturing cost.

### BACKGROUND OF THE INVENTION

Along with enhancement of scientific technology and living quality, information products have gone deep into every aspect of life. As compared to conventional cathode ray tube (CRT) displays, because the liquid crystal displays (LCDs) have the advantages of small volume, no glittering, low radiation, and power saving, they are more and more popular in the market. In general portable products like personal digital assistants (PDAs), mobile phones, or digital still cameras (DSCs), the panels thereof usually adopt the design of black-and-white display, hence having limited effect. Therefore, in order to achieve multi-color or full-color displaying effect, it is usually necessary to dispose a color filter in an LCD. Through the help of the color filter to display the three primary colors of red (R), green (G), and blue (B), full-color displaying mode can then be achieved by mixing different ratios of the three primary colors.

However, the color filter is expensive and has a high manufacturing cost. Because the required number of colors of the above small LCD panel is less, the price of this kind of products will go through the roof if the expensive color filter is applied to this kind of portable products, hence deteriorating the sell. Moreover, these small products have much limited display screens, and only need multi-color displaying effect.

Accordingly, the present invention aims to propose a multi-color LCD device, which utilizes combinations and variations of a plurality of liquid crystal layers and several polarizers to achieve multi-color displaying object so as to resolve the above problems.

### SUMMARY OF THE INVENTION

The primary object of the present invention is to propose a multi-color LCD device, wherein at least two liquid crystal panels and several polarizers are matched to achieve the effect of color display, hence applying to some portable products requiring less number of colors.

Another object of the present invention is to provide a multi-color LCD device having a low price.

According to the present invention, an LCD device comprises at least two liquid crystal panels stacked up and down. A first polarizer, a second polarizer, and a third polarizer or a reflector are disposed above, between, and below the two liquid crystal panels, respectively. Each of the polarizers has a transmission axis and an absorption axis orthogonal to each other. The transmission axis of each of the polarizers lets white light be transmitted. The absorption axis of at least one polarizer absorbs light in the wavelength range of a single color plates, and the absorption axes of other polarizers absorb white light.

The various objects and advantages of the present invention will be more readily understood from the following detailed description when read in conjunction with the appended drawings, in which:

### BRIEF DESCRIPTION OF THE DRAWINGS

FIG. 1 is a structure diagram of a four-color LCD of the present invention;

FIG. 2 is an action diagram of a color polarizer of the present invention;

FIGS. 3a to 3d show diagrams of four driving modes of FIG. 1;

FIG. 4 is a structure diagram according to another embodiment of the present invention; and

FIG. 5 is a structure diagram according to yet another embodiment of the present invention.

### DETAILED DESCRIPTION OF THE PREFERRED EMBODIMENTS

The present invention adopts the design of more than two liquid crystal panels matched with color polarizers to let an LCD device achieve multi-color displaying object without any color filter. A four-color LCD device using twisted nematic (TN) mode will be described below to illustrate characteristics of the present invention.

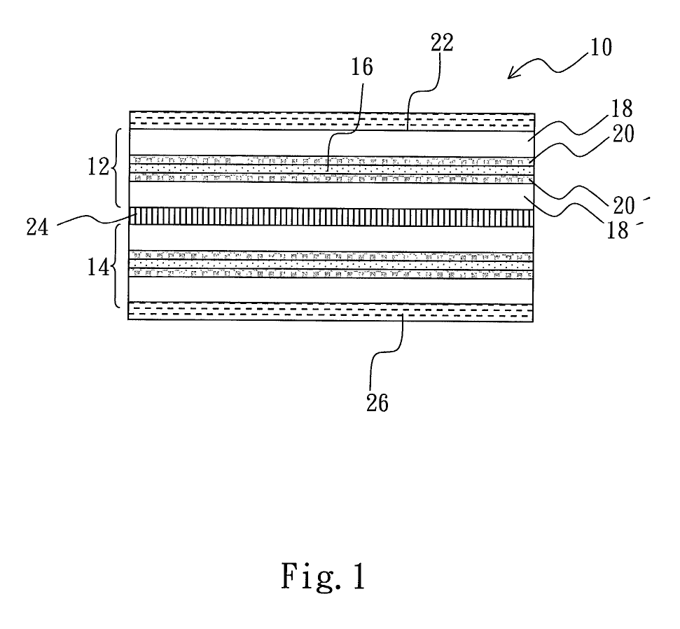

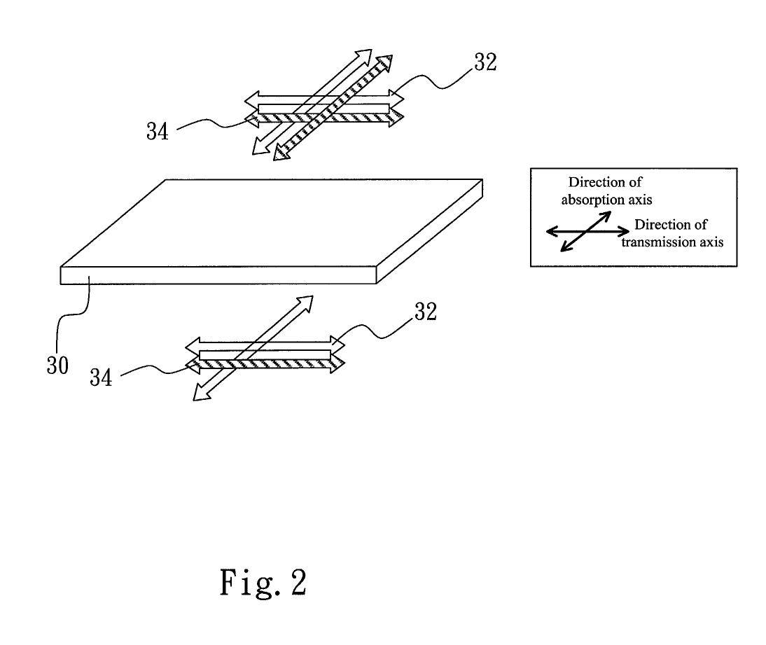

As shown in FIG. 1, a four-color LCD device 10 comprises a first liquid crystal panel 12 and a second liquid crystal panel 14. Each of the two liquid crystal panels 12 and 14 is composed of a pair of opposite transparent substrates 18 and 18′ with a liquid crystal layer 16 sandwiched between them. Transparent electrode layers 20 and 20′ are disposed on two opposite inner surfaces of the two transparent substrates 18 and 18′. The first and second liquid crystal panels 12 and 14 and stacked up and down. A first polarizer 22, a second polarizer 24, and a third polarizer 26 are also provided. Each of the three polarizers has a transmission axis and an absorption axis (not shown) orthogonal to each other. The first polarizer 22, the second polarizer 24, and the third polarizer 26 are disposed above the first liquid crystal panel 12, between the first and second liquid crystal panels 12 and 14. And below the second liquid crystal panel 14, respectively. The first and second polarizers 22 and 24 are color polarizers. In other words, when light passes through the polarizer 22 or 24, the transmission axis thereof will let light be completely transmitted, while the absorption axis thereof will absorb light in the wavelength range of a single color. A red polarizer 30 is exemplified in FIG. 2. The transmission axis of the red polarizer 30 is horizontal, and the absorption axis thereof is vertical. When a light is split into a red light 32 and a cyan light 34 of complementary color, both the red light 32 and the cyan light 34 can pass through the transmission axis of the red polarizer 30. The absorption axis of the red polarizer 30 will absorb the cyan light 34 and let the red light 32 be transmitted. The third polarizer 26 is a common polarizer. That is, when light passes through the third polarizer 26, the transmission axis thereof will let light be completely transmitted, while the absorption axis thereof will completely absorb light.

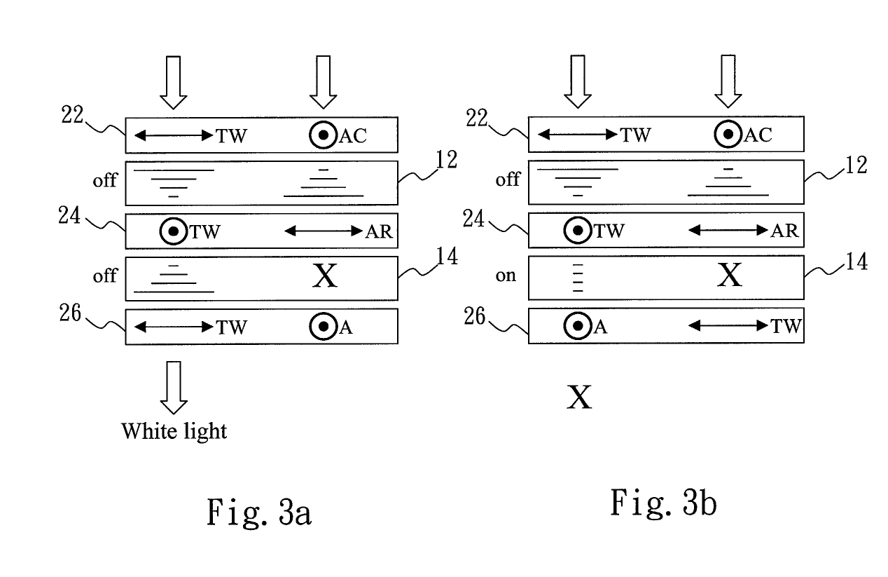

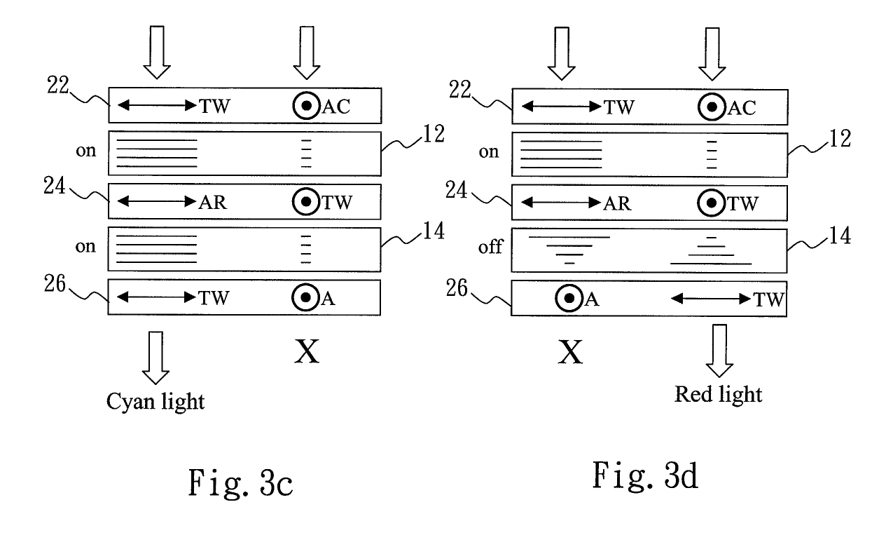

When there is no voltage applied (off state), liquid crystal molecules of the liquid crystal layer 16 will align toward a certain direction according the direction of thin trenches of an orientation film, and twist 90 degrees between the upper and lower transparent electrodes 20 and 20′. When a voltage is applied across the transparent electrode layers 20 and 20′ (on state), the alignment direction of liquid crystal molecules will be altered to be parallel to the electric field. In the present invention, presentation of different colors is controlled by whether a voltage is applied onto the two liquid crystal panels 12 and 14. FIGS. 3a to 3d show four driving modes of the two liquid crystal panels 12 and 14. The transmission axis and the absorption axis of the first polarizer 22 are parallel (denoted by [symbol] ) and normal (denoted by [symbol] ) to the paper, respective. The absorption axis thereof absorbs cyan light (i.e., only letting red light be transmitted, denoted by AC). The transmission axis and the absorption axis of the second polarizer 24 are normal and parallel to the paper, respective. The absorption axis thereof absorbs red light (i.e., only letting cyan light be transmitted, denoted by AR). The transmission axis and the absorption axis of the third polarizer 26 are parallel and normal to the paper, respective. The transmission axis thereof lets white light be transmitted and the absorption axis thereof completely absorbs white light, which are denoted by TW and A, respectively.

When there is no voltage applied onto the first liquid crystal panel 12 (off state), as shown in FIG. 3a, because the transmission axis (parallel to the paper) of the first polarizer 22 is TW and the absorption axis thereof (normal to the paper) is AC, after an incident light enters the first polarizer 22, a white polarized light parallel to the paper and a red polarized light normal to the paper will be obtained. These two polarized lights will rotate 90 degrees along with twist of liquid crystal molecules of the first liquid crystal panel 12 to become a while polarized light normal to the paper and a red polarized light parallel to the paper, which then enter into the second polarizer 24. Because the transmission axis (normal to the paper) of the second polarizer 24 is TW and the absorption axis thereof (parallel to the paper) is AR, the red polarized light parallel to the paper will be absorbed, while the white polarized light normal to the paper will pass through the transmission axis to still be a white polarized light normal to the paper, which then enters into the second liquid crystal panel 14. If there is no voltage applied onto the second liquid crystal panel 14 (off state), the white light will rotate 90 degrees along with twist of liquid crystal molecules of the second liquid crystal panel 14 to become a while polarized light parallel to the paper, which then enters into the third polarizer 26. Because the transmission axis of the third polarizer 26 is parallel to the paper, the white polarized light will be transmitted successfully to form a white color display. If a voltage is applied onto the second liquid crystal panel 14 (on state), as shown in FIG. 3b, the white polarized light normal to the paper will not rotate along with liquid crystal molecules. The white polarized light thus cannot pass through the third polarizer 26, hence forming a black color display.

When a voltage is applied onto the first liquid crystal panel 12 (on state), as shown in FIG. 3c, a white polarized light parallel to the paper and a red polarized light normal to the paper obtained after an incident light passes through the first polarizer 22 will not rotate along with twist of liquid crystal molecules to be still a while polarized light parallel to the paper and a red polarized light normal to the paper, which then enter into the second polarizer 24. Because the transmission axis (normal to the paper) of the second polarizer 24 is TW and the absorption axis thereof (parallel to the paper) is AR, the red component of the white polarized light parallel to the paper will be absorbed when passing through the absorption axis to obtain a cyan polarized light parallel to the paper. The red polarized light parallel to the paper will successfully pass through the second polarizer 24 to simultaneously enter into the second liquid crystal panel 14 with the cyan polarized light. If a voltage is applied onto the second liquid crystal panel 14 (on state), these two polarized lights will still be a cyan polarized light parallel to the paper and a red polarized light normal to the paper after passing through the second liquid crystal panel 14 and then enter into the third polarizer 26. The third polarizer 26 will absorb the red polarized light normal to the paper and only let the cyan polarized light parallel to the paper be transmitted, hence forming a cyan display. If there is no voltage applied onto the second liquid crystal panel 14 (off state), the cyan polarized light parallel to the paper and the red polarized light normal to the paper will rotate 90 degrees along with twist of liquid crystal molecules to become a cyan polarized light normal to the paper and a red polarized light parallel to the paper after passing through the second liquid crystal panel 14. The third polarizer 26 will absorb the cyan polarized light normal to the paper and only let the red polarized light parallel to the paper be transmitted, hence forming a red display.

The present invention uses two liquid crystal panels 12 and 14 matched with the three polarizers 22, 24, and 26 to let the LCD device 10 have white, black, red, and cyan displaying modes. Through proportional mixing of colors and matched with gray-scale driving, an LCD device will have a colorful displaying effect without any expensive color filter. The LCD device thus has the advantage of low cost and applies to display panels of portable electronic products.

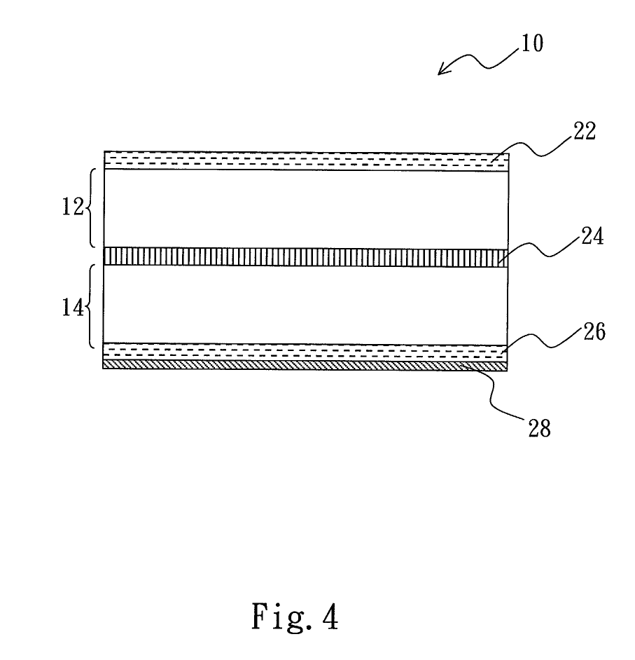

The above two liquid crystal panels 12 and 14 can also use super twisted nematic (STN) mode, film super twisted nematic (FSTN) mode, or thin film transistor (TFT) mode. In addition to the above transmitive mode LCD device, a reflector 28 can be disposed on the lower surface of the third polarizer 26 to form a reflective mode LCD device, as shown in FIG. 4. The reflector 28 can also be a semi-reflector having partly reflective and partly transmitive function to form a transflective mode LCD device.

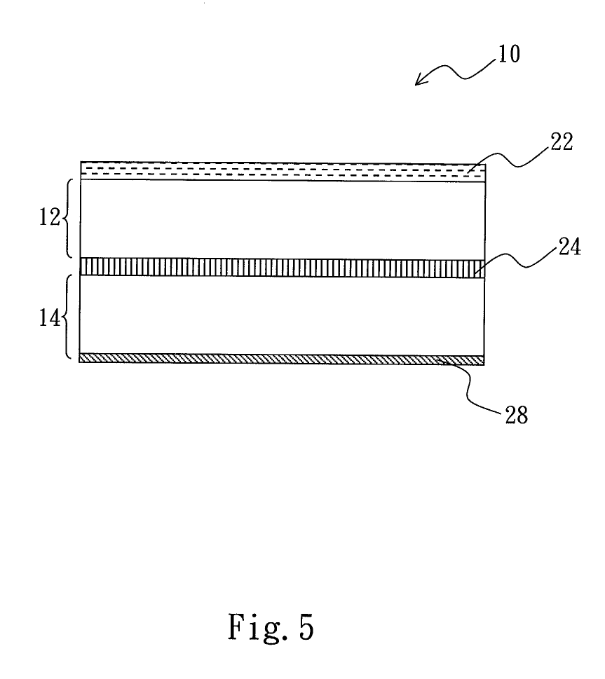

Besides, the above third polarizer 26 can also be replaced with a reflector, as shown in FIG. 5. In other words, a reflector 28 is disposed on the lower surface of the lower transparent substrate 18′ of the second liquid crystal panel 14. A light passing through the second liquid crystal panel 14 is reflected by the reflector 28 and then acted on in order by the second liquid crystal panel 14, the second polarizer 24, the first liquid crystal panel 12, and the first polarizer 22 to form different color displays, hence having a multi-color displaying effect. The reflector can also be disposed on the upper surface of the lower transparent substrate.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A multi-color liquid crystal display device, comprising:
at least two liquid crystal panels stacked up and down, said two liquid crystal panels being an upper liquid crystal panel and a lower liquid crystal panel; and
at least three polarizers respectively disposed above said upper liquid crystal panel, between said two liquid crystal panels, and below said lower liquid crystal panel, at least one of said polarizers being a color polarizer, an absorption axis of said color polarizer absorbing light in the wavelength range of a single color while a transmission axis thereof letting white light be transmitted, absorption axes of other polarizers absorbing white light while transmission axes thereof letting white light be transmitted.

2. The multi-color liquid crystal display device as claimed in claim 1, wherein said two liquid crystal panels adopt twisted nematic mode, super twisted nematic mode, film super twisted nematic mode, or thin film transistor mode, and the modes adopted by said two liquid crystal panels can be the same or different.

3. The multi-color liquid crystal display device as claimed in claim 1, wherein a reflector is disposed on a lower surface of said undermost polarizer.

4. The multi-color liquid crystal display device as claimed in claim 1, wherein a transflective plate is disposed on a lower surface of said undermost polarizer.

5. A multi-color liquid crystal display device, comprising:
at least two liquid crystal panels stacked up and down, said two liquid crystal panels being an upper liquid crystal panel and a lower liquid crystal panel;
at least two polarizers respectively disposed above said upper liquid crystal panel and between said two liquid crystal panels, at least one of said polarizers being a color polarizer, an absorption axis of said color polarizer absorbing light in the wavelength range of a single color while a transmission axis thereof letting white light be transmitted, absorption axes of other polarizers absorbing white light while transmission axes thereof letting white light be transmitted; and
a reflector disposed on said lower liquid crystal panel.

6. The multi-color liquid crystal display device as claimed in claim 5, wherein said two liquid crystal panels adopt twisted nematic mode, super twisted nematic mode, film super twisted nematic mode, or thin film transistor mode, and the modes adopted by said two liquid crystal panels can be the same or different.

7. The multi-color liquid crystal display device as claimed in claim 5, wherein said liquid crystal panel is composed of a pair of opposite transparent substrates with a liquid crystal layer sandwiched between them, transparent electrode layers are respectively disposed on opposite inner surfaces of said two transparent substrates, and said reflector is disposed on an upper surface of a lower surface of said lower transparent substrate of said lower liquid crystal panel.
